(19) United States
(12) Patent Application Publication
(10) Pub. No.: US 2020/0153605 A1
(43) Pub. Date: May 14, 2020

(54) SYSTEMS AND METHODS FOR PRE-EXECUTING TRANSACTION VALIDATION FOR BLOCKCHAIN APPLICATIONS

(71) Applicant: Accelor Ltd., George Town (KY)

(72) Inventors: Shiwen HU, Sunnyvale, CA (US); Xiaohan MA, Santa Clara, CA (US); Guojun CHU, Saratoga, CA (US)

(21) Appl. No.: 16/188,783

(22) Filed: Nov. 13, 2018

(51) Int. Cl. H04L 9/06; G06F 16/23; H04L 9/32

(52) U.S. Cl. CPC H04L 9/0637; G06F 16/2379; H04L 67/2842; H04L 2209/38; H04L 9/3247

(57) ABSTRACT

Systems and methods related to processing transaction verification operations in decentralized applications via a fixed pipeline hardware architecture are described herein. The fixed pipeline architecture may comprise one or more hardware components configured to pre-execute transactions (or perform one or more transaction verification operations) for a decentralized application while a block comprising transactions is being generated. For example, the fixed pipeline architecture may prefetch data required to validate a transaction prior to the generation of a new block comprising the transaction and cache the prefetched data in a local buffer. In some implementations, prior to the generation of a block comprising at least one transaction, cryptographic signatures associated with the transaction may be verified and/or the transaction itself may be verified by comparing the local state and the transaction state for the transaction.

### FIELD OF THE INVENTION

The invention relates to systems and methods for processing transaction verification operations in decentralized applications via a fixed pipeline hardware architecture.

### BACKGROUND OF THE INVENTION

Decentralized applications are applications that run on peer-to-peer networks, rather than on a single computer. Transactions associated with decentralized applications are typically processed by nodes (or computers) on the peer-to-peer network based on trustless protocols or a series of validation rules established by the creators of the decentralized application. A critical component of decentralized applications is the manner in which transactions associated with the decentralized application are verified and recorded.

In many decentralized applications, verified transactions and/or other information is committed to a blockchain. Many types of blockchains exist. In general, they are distributed ledgers shared by the nodes on a network to which transactions are recorded and validated. A block is a part of a blockchain, in which some or all of the recent transactions may be recorded. Once completed, a block is stored in the blockchain as a permanent database. Each time a block gets completed, a new one is generated. Each block in the blockchain is connected to the others (like links in a chain) in proper linear, chronological order. Every block contains a hash of the previous block. The blockchain has information about different user addresses and their balances right from the genesis block to the most recently completed block. Once a block is inserted into (or committed to) a blockchain, its content may not be changed, and the block may not be moved or removed from the blockchain. This immutability of the blockchain is guaranteed by the hashes and signatures stored in the blocks.

Recent advances in decentralized applications have enabled high-throughput transaction processing speed. Conventionally, increased throughput transaction processing speed has been achieved via software stack development and/or protocol consolidation. However, many of the operations required to verify transactions are computationally intensive. As a result, users in decentralized applications may be incentivized to skip verification operations to preserve computational resources and apply them in a manner that may benefit them financially, but also create security concerns and limit the scalability of the decentralized application. This is sometimes referred to as the “verifier's dilemma.” It would be desirable to provide systems and methods that encompass a hardware solution to the verifier's dilemma by facilitating increased throughput transaction processing speed in decentralized application via a fixed pipeline hardware architecture.

### SUMMARY OF THE INVENTION

The systems and methods described herein relate to a fixed pipeline hardware architecture configured to process transaction verification operations for decentralized applications. The fixed pipeline hardware architecture may comprise and/or be incorporated within a self-contained hardware device comprising electronic circuity configured to be communicatively coupled or physically attached to a component of a computer system. The fixed pipeline hardware architecture may include and/or support at least a high-speed direct memory access (DMA) configured to access a ledger stored in local memory, a crypto engine, a read set validation engine, and/or one or more other components, engines, or modules configured to accelerate the transaction verification process. In some implementations, the fixed pipeline architecture may include multiple crypto engines and/or multiple read set validation engines based on performance, cost, or power tradeoffs.

In various implementations, the systems and methods described herein may pre-execute transactions (or perform one or more transaction verification operations) for a decentralized application while a block comprising transactions is being generated. For example, the systems and methods described herein may relate to a validation peer that represents a single node in a peer-to-peer network that is configured to process transactions associated with a decentralized application. To facilitate increased throughput transaction processing speed, the validation peer may perform one or more actions during the ordering phase for a given transaction.

The life cycle of a transaction involves several critical stages: (i) transaction creation; (ii) endorsement; (iii) ordering; (iv) validation; and (v) commitment. At the outset, a transaction may be created in numerous circumstances. In decentralized applications, when a transaction is created, at least one endorsement is required. Another user (such as a banker in the case of a bank transaction) may endorse a user's transaction. Once a contract is endorsed, a request may be sent to an ordering service responsible for generating a block. Each block may comprise multiple transactions, and the ordering service may order (or sequence) the multiple transactions, generate a new block comprising the multiple transactions based on the order, and transmit the block to nodes (or peers) on a peer-to-peer network for validation. Once the transactions are validated, the block comprising the transactions may be committed to a blockchain. In various implementations described herein, the validation peer may perform one or more actions to validate new transactions prior to the generation of a new block comprising the new transactions.

In various implementations, a validation peer may be configured to monitor network for traffic for new transactions prior to the generation of a new block comprising the transactions. For example, network traffic may be snooped for new transactions to be ordered during the ordering phase. The validation peer may obtain a read set and/or a write set for a new transaction identified prior to the generation of a new block comprising the transaction. In some implementations, prefetched read sets and/or write sets for new transactions may be inserted into a prefetching buffer. In various implementations, data stored in electronic memory that is required to verify the transaction and/or cryptographic signatures associated with the transaction may be prefetched based on the read set associated with at least one transaction to be ordered. For example, the data may include a local state related to a transaction, cryptographic signatures need to verify the cryptographic signatures of the transaction, and/or other data stored in electronic memory. The validation peer may be configured to cache copies of the fetched data related to the transaction prior to the generation of a new block comprising the transaction. When a new block is received, transactions within the block may be validated as described herein based at least in part on data cached in a local buffer, thereby improving the throughput transaction processing speed.

Validating a transaction included within a received block may include validating the endorsing signatures of the transaction and verifying the transaction is valid by comparing the required pre-existing conditions for the transaction against a current state. For example, the current state may comprise a current value in an account of a user (e.g., a broker account in the event the transaction comprises a stock sale). To validate the transaction, the cryptographic signatures must be verified, and it must be determined that the local state (e.g., current account) supports the transaction (e.g., the account has sufficient funds to execute the transaction). In various implementations, a transaction may be verified by comparing a transaction state for a transaction against a local state related to the transaction that is cached in a local buffer prior to the generation of the new block comprising the transaction. Responsive to the verification of both the transaction and the cryptographic signatures associated with the transaction, the transaction may be committed to a blockchain and a local state related to the transaction may be updated in electronic memory (thereby updating the distributed ledger).

In some implementations, the cryptographic signatures associated with a transaction may be verified prior to the generation of a new block comprising the transaction. For example, cryptographic signatures required to verify the cryptographic signatures for a new transaction identified prior to the generation of a block comprising the new transaction may be prefetched based on a read set for the new transaction. The results of the signature validation may be cached in a buffer at least until they are compared to results of a read set validation (i.e., verification of the transaction by comparing the local state and the transaction state for the transaction). Cryptographic signature validation may be performed during the ordering phase as the results of cryptographic signature validation does not depend on the order of the transactions in a block. By prefetching data needed to process a transaction and performing cryptographic signature validation for the transaction prior to a block being generated comprising the transaction (i.e., during the ordering phase), throughput transaction processing speed may be improved even further.

In some implementations, a transaction may be verified by comparing the local state and the transaction state for the transaction prior to the generation of new block comprising that transaction. In the event a transaction is verified prior to the generation of a new block comprising that transaction, the transaction may be reverified after the block is generated. For example, a single block may comprise multiple transactions associated with a single user (or cryptographic signature). In some implementations, an order of multiple transactions associated with a single user (or cryptographic signature) may be detected and the multiple transactions associated with the single user (or cryptographic signature) may be reverified based on the detected order of the multiple transactions.

These and other objects, features, and characteristics of the system and/or method disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 depicts a block diagram of an example of a system configured to process transaction verification operations in decentralized applications, in accordance with one or more implementations of the invention.

FIG. 2 illustrates a block diagram of an example of a read set validation engine configured to fetch ledger data and validate the ledger reading set against the global state, in accordance with one or more implementations of the invention.

FIG. 3 illustrates a block diagram of an example of a crypto engine configured to perform one or more cryptographic operations required to verify the authenticity of transactions in a block, in accordance with one or more implementations of the invention.

FIG. 4 illustrates a block diagram of an example of a system configured to pre-execute transactions for a decentralized application while a block comprising the transactions is being generated, in accordance with one or more implementations of the invention.

FIG. 5 illustrates a block diagram of an example of a system configured to pre-execute transactions for a decentralized application while a block comprising the transactions is being generated, in accordance with one or more implementations of the invention.

FIG. 6 depicts a flowchart of an example of a method for pre-executing transactions for a decentralized application while a block comprising the transactions is being generated, in accordance with one or more implementations of the invention.

### DETAILED DESCRIPTION OF THE INVENTION

The systems and methods described herein related to a fixed pipeline hardware architecture configured to process transaction verification operations in decentralized applications. The fixed pipeline architecture may comprise one or more hardware components configured to pre-execute transactions (or perform one or more transaction verification operations) for a decentralized application while a block comprising transactions is being generated. In some implementations, the fixed pipeline architecture may prefetch data required to validate a transaction prior to the generation of a new block comprising the transaction and cache the prefetched data in a local buffer. To validate the transaction, the hardware components may obtain the cached data from the local buffer instead of obtaining the required data from electronic memory, thereby increasing throughput transaction processing speed. In some implementations, cryptographic signatures associated with a transaction may be verified prior to the generation of a new block comprising the transaction. In some implementations, a transaction may be verified by comparing the local state and the transaction state for the transaction prior to the generation of new block comprising that transaction. In the event a transaction is verified prior to the generation of a new block comprising that transaction, the transaction may be reverified after the block is generated based on the order of the transactions in the block.

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

### Exemplary System Architecture

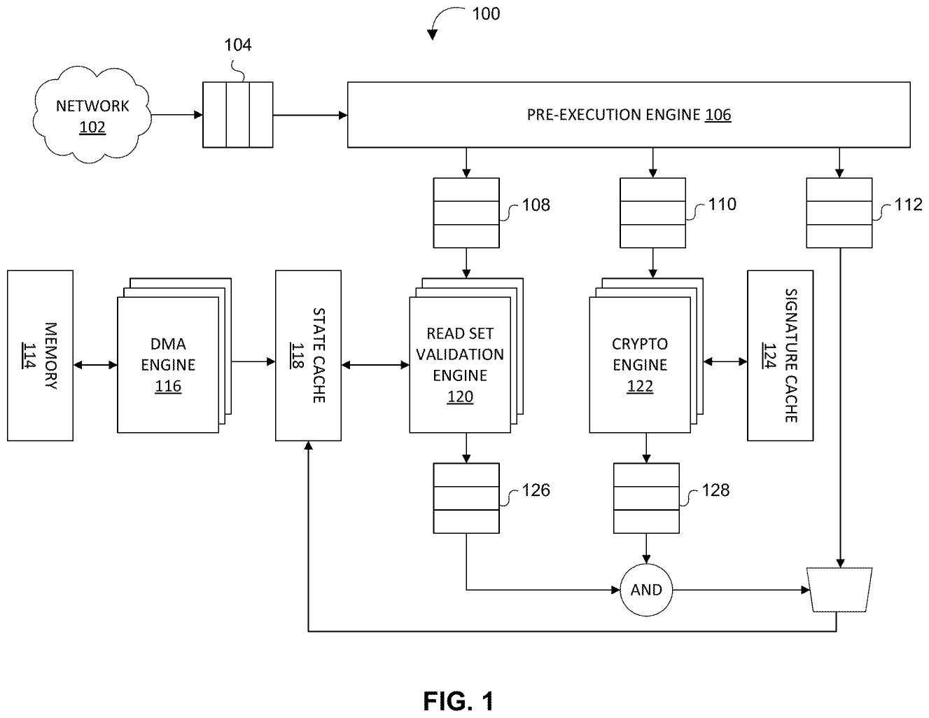

FIG. 1 depicts a block diagram of an example of a system 100 configured to process transaction verification operations in decentralized applications, in accordance with one or more implementations of the invention. In various implementations, system 100 may comprise a hardware device. For example, system 100 may comprise one or more processing devices (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) configured to accelerate the transaction verification process. In some implementations, system 100 may comprise a single self-contained hardware device configured to be communicatively coupled or physically attached to a component of a computer system. In an exemplary implementation, system 100 may comprise electronic circuitry and/or a printed circuit board that can be inserted into an electrical connector or expansion slot of a computer system. For example, system 100 may comprise an expansion card, expansion board, adapter card, or accessory card configured to accelerate the transaction verification process. In some implementations, system 100 may comprise an application specific integrated circuit (ASIC) or a field-programmable gate array (FPGA) configured to perform transaction verification operations associated with one or more decentralized applications.

System 100 may include one or more hardware components. In various implementations, the one or more hardware components of system 100 may include an incoming block buffer 104, a pre-execution engine 106, a read set holding buffer 108, a signature validation buffer 110, a write set holding buffer 112, local memory 114, a DMA engine 116, a state cache 118, a read set validation engine 120, a crypto engine 122, a signature cache 124, a read set validation result buffer 126, a signature validation result buffer 128, and/or other components. In various implementations, the one or more hardware components of system 100 may form a fixed pipeline hardware architecture configured to accelerate the transaction verification process. For example, the one or more hardware components may configure system 100 to verify the authenticity of transactions in a block, check the validity of the transactions, and/or commit (or write) the block and the validation results onto the blockchain.

System 100 may be configured to accelerate the verification of transactions received via network 102. System 100 may be configured to receive a block comprising a set of transactions via network 102. In various implementations, incoming block buffer 104 may be configured to cache the received block. In some implementations, incoming block buffer 104 may be configured to cache the received block prior to pre-execution of the received block.

In various implementations, system 100 may include a pre-execution engine 106. Pre-execution engine 106 may be configured to conduct pre-execution of new transactions while a new block is being created. By pre-executing the transaction validations, pre-execution engine 106 may significantly reduce the latency of a transaction's life cycle and greatly improve the throughput of a computer system to which system 100 is communicatively coupled and/or physically attached.

Blocks received and cached in incoming block buffer 104 may be inserted into one of a set of queues. A block comprising a set of transactions may include a ledger reading set, cryptographic signatures to be authenticated, and a ledger writing set. In various implementations, the ledger reading set of an incoming block may be inserted into read set holding buffer 108, cryptographic signatures of an incoming block to be authenticated may be inserted into signature validation buffer 110, and the ledger writing set of an incoming block may be inserted into write set holding buffer 112. In order for a transaction to be validated, both the ledger reading set and cryptographic signatures must be valid. If valid, the ledger writing set is applied to the global state (as described further herein). If not valid, the ledger writing set will not be applied to the global state. All valid information for a transaction is saved and committed (written) into the blockchain.

In various implementations, system 100 may include one or more of read set validation engine 120 and crypto engine 122. Accordingly, system 100 may include multiple read set validation engines 120 and/or multiple crypto engines 122. In some implementations, system 100 may include multiple read set validation engines 120 and/or multiple crypto engines 122 based on performance tradeoffs, cost tradeoffs, and/or power tradeoffs. As such, system 100 may be configurable based on the number of read set validation engines 120 and/or crypto engines 122 contained therein.

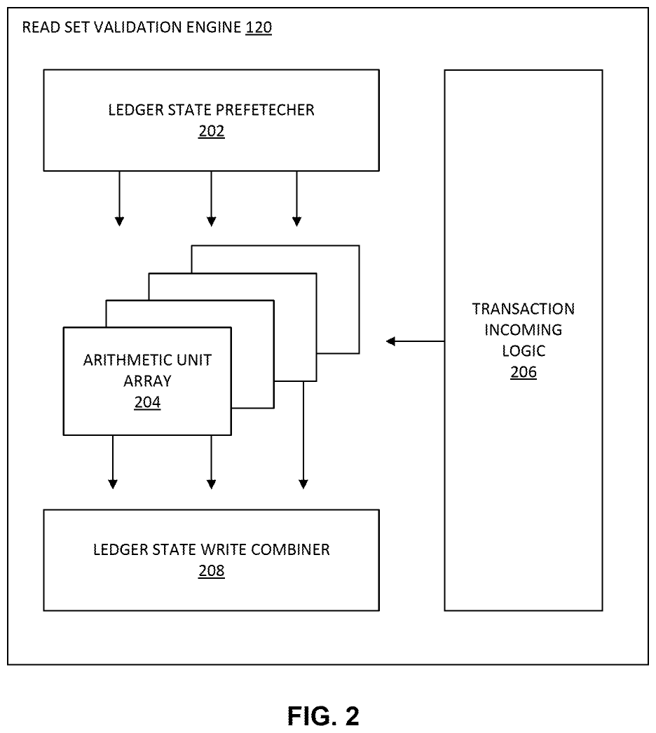

Each read set validation engine 120 may be configured to fetch ledger data and validate the ledger reading set against the global state. The global state may refer to the current status related to one or more data points in a verified ledger written to the blockchain. In various implementations, read set validation engine 120 may be configured to receive the ledger reading set of an incoming block from read set holding buffer 108. Read set validation engine 120 may be configured to interface with state cache 118 to obtain and cache data required to validate ledger reading set against the global state. In various implementations, the results of the ledger reading set validation by read set validation engine 120 may be cached in read set validation result buffer 126 at least until they are compared to results of the signature validation by crypto engine 122. Read set validation engine 120 is further described herein in connection with FIG. 2.

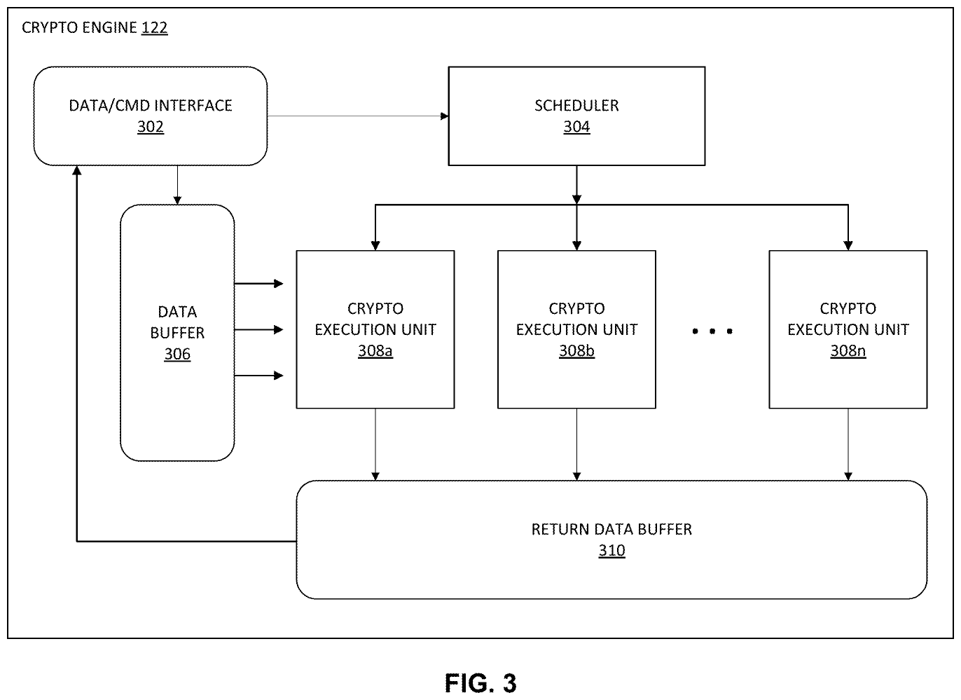

Each crypto engine 122 may comprise one or more cryptographic functional units. Each cryptographic functional unit may comprise a core configured to perform one or more cryptographic operations required to verify the authenticity of transactions in a block. For example, the one or more cryptographic operations may comprise crypto signature generation (encrypt) operations and crypto signature verification (decrypt) operations. In various implementations, crypto engine 122 may be configured to receive cryptographic signatures of a block to be authenticated from signature validation buffer 110. Crypto engine 122 may be configured to interface with signature cache 124 to obtain and cache data required to authenticate cryptographic signatures associated with a transaction. In various implementations, the results of the signature validation by crypto engine 122 may be cached in signature validation result buffer 128 at least until they are compared to results of the read set validation by read set validation engine 120. Crypto engine 122 is further described herein in connection with FIG. 3.

In various implementations, system 100 may comprise a direct memory access (DMA) engine 116. DMA engine 116 may be configured to fetch data required to verify the authenticity and read set data of a transaction. For example, DMA engine 116 may be configured to fetch existing blocks and signatures associated with a transaction. In various implementations, DMA engine 116 may be configured to access a ledger in memory required to validate data associated with a transaction. For example, DMA engine 116 may be configured to access local memory 114 to obtain a ledger required to validate data associated with a transaction.

In various implementations, read set validation result buffer 126 may comprise a cache of results of the ledger reading set validation by read set validation engine 120 and signature validation result buffer 128 may comprise a cache of the results of the signature validation by crypto engine 122.

In various implementations, system 100 may be configured to compare the results of the ledger reading set validation cached in read set validation result buffer 126 and the results of the signature validation cached in signature validation result buffer 128. Regardless of the results of the ledger reading set validation and the results of the signature validation or the comparison thereof, system 100 is configured to commit (or write) the transaction to the blockchain. However, based on the comparison of the results of the ledger reading set validation and the results of the signature validation, system 100 may also write the transaction to the state cache and update the global state based on the transaction. Specifically, if both the ledger reading set and the cryptographic signatures are valid, system 100 may be configured to write the transaction to the state cache and update the global state based on the transaction. In order to update the global state based on the transaction, the ledger writing set is applied to the global state. For example, if system 100 determines that both the ledger reading set and the cryptographic signatures are valid for a given transaction, a ledger writing set associated with that transaction cached in write set holding buffer 112 may be applied to the global state to update the global state based on the transaction. If either the ledger reading set or the cryptographic signatures are invalid, system 100 is specifically configured to not update the global state based on the transaction. If the ledger reading set is not valid, it may be due to the fact that there are insufficient funds to process the transaction or that the ledger reading set otherwise indicates that one or more conditions associated with the transaction have not been satisfied. Accordingly, system 100 will not process the transaction by updating the global state. Similarly, if the cryptographic signatures are invalid, it may indicate a potential hack has occurred. Accordingly, system 100 will not process the potentially fraudulent transaction by updating the global state.

In various implementations, the hardware device of system 100 may be configured to cooperate with a computer (or computer processing unit) that serves as a single node in a peer-to-peer network that is configured to process transactions associated with a decentralized application. For example, the hardware device may be installed in, communicatively coupled to, and/or otherwise associated with the computer. The computer may be physically and/or communicatively coupled to electronic storage configured to store a copy of a ledger shared by a plurality of nodes on the network. In some implementations, the copy of the ledger maintained and stored in electronic storage of the computer may comprise a read and write copy of the ledger. In other implementations, the copy of the ledger maintained and stored in electronic storage of the computer may comprise a read-only copy of the ledger. The computer may be configured to perform one or more distributed ledger operations based on the copy of the ledger stored in electronic storage. In various implementations, the hardware device of system 100 may be configured to maintain a shadow copy of the ledger shared by the plurality of nodes on the network and perform one or more distributed ledger operations based on the shadow copy of the ledger. In various implementations, the computer and the hardware device of system 100 may each be configured to perform one or more separate and distinct operations and maintain separate and distinct copies of the ledger shared by a plurality of nodes on a peer-to-peer network. For example, the computer and the hardware device may each perform one or more separate and distinct operations and maintain separate and distinct copies of the ledger as described in co-pending U.S. patent application Ser. No. 16/160,161, entitled “SYSTEMS AND METHODS FOR SECURE SMART CONTRACT EXECUTION VIA READ-ONLY DISTRIBUTED LEDGER,” Attorney Docket No. 63PF-274818, the disclosure of which is hereby incorporated by reference in its entirety herein.

### Read Set Validation

FIG. 2 illustrates a block diagram of an example of read set validation engine 120 configured to fetch ledger data and validate the ledger reading set against the global state, in accordance with one or more implementations of the invention. Read set validation engine 120 may comprise an architecture configured to validate read set data by determining whether a global state satisfies the current requirements of a transaction. In various implementations, one or more hardware components of read set validation engine 120 may form a fixed pipeline hardware architecture configured to fetch ledger data and validate the ledger reading set against the global state for a given transaction. In various implementations, the one or more hardware components of read set validation engine 120 may include a ledger state prefetcher 202, an arithmetic unit array 204, transaction incoming logic 206, a ledger state write combiner 208, and/or one or more other components. Read set validation engine 120 may be configured to obtain data necessary to validate the ledger reading set against the global state from local memory (such as memory 114 and/or state cache 118). In various implementations, read set validation engine 120 may include an input interface from DMA. For example, read set validation engine 120 may include an input interface from DMA engine 116.

In various implementations, read set validation engine 120 may comprise a ledger state prefetcher 202 configured to fetch data required by read set validation engine 120. In some implementations, ledger state prefetcher 202 may be configured to fetch a ledger state from state cache 118. In some implementations, ledger state prefetcher 202 may be configured to fetch a ledger state from state cache 118 via a high-speed memory interface. In some implementations, ledger state prefetcher 202 may be configured to prefetch a ledger state from state cache 118. Fetching from local memory would require accessing the entire memory, which would slow down throughput speed in the read set validation engine. Prefetching the ledger state from state cache 118 (which is local memory) would provide read set validation engine 120 with data from local memory without having to access the entire local memory for each computation. In various implementations, read set validation engine 120 may include transaction incoming logic 206 configured to extract state information from an incoming transaction. Accordingly, ledger state prefetcher 202 may be configured to obtain a local state from memory and transaction incoming logic 206 may be configured to obtain an incoming transaction state from the transaction data.

In various implementations, read set validation engine 120 may include arithmetic unit array 204 configured to perform a read set comparison against pre-executed results. In various implementations, arithmetic unit array 204 may be configured to perform computing tasks to verify transactions. In some implementations, arithmetic unit array 204 may be configured to operate in parallel. In other words, arithmetic unit array 204 may be configured to perform parallel processing of validation compute tasks for a single transaction and/or different transactions simultaneously. In various implementations, arithmetic unit array 204 may be configured to verify that a local copy of a state (obtained from memory) and the incoming transaction state match.

In various implementations, read set validation engine 120 may include ledger state write combiner 208 configured to perform a burst write for transaction results to the resulting buffer (i.e., read set validation result buffer 126). If an incoming transaction is validated (if the local copy of a state and the incoming transaction state match), ledger state write combiner 208 may be configured to combine states together and write to read set validation result buffer 126.

In an exemplary implementation in which a decentralized application involves a banking institution, each of the bank customers with an account may have their account written to a blockchain. Accordingly, the current status of each account and a history of every transaction involving each account is written to the blockchain, and the current status of each account would comprise the global state. In this exemplary implementation, system 100 may be configured to verify a block comprising a set of transactions involving bank customers. Transaction incoming logic 206 may be configured to obtain an incoming transaction state from the transaction data. For example, transaction incoming logic 206 may be configured to determine that a transaction involving a first bank customer involves a stock purchase for $3,000 and a transaction involving a second bank customer involves a transfer of $4,000. Read set validation engine 120 may be configured to obtain from memory (e.g., memory 114) a local state. The local state may comprise the global state indicating that a current account of the first customer comprises $2,000 and that a current account of the second customer comprises $8,000. Read set validation engine 120 may be configured to determine whether the current state meets the requirements for a given transaction. For example, arithmetic unit array 204 may be configured to compare the local state of the first customer (i.e., $2,000) and the incoming transaction state for the transaction involving the first customer (i.e., a transaction requiring $3,000), and compare the local state of the second customer (i.e., $8,000) and the incoming transaction state for the transaction involving the second customer ($4,000). Accordingly, read set validation engine 120 may be configured to determine that the transaction involving the first bank customer is invalid and that the transaction involving the second bank customer is valid.

In various implementations, the results of the ledger reading set validation by read set validation engine 120 may be cached in read set validation result buffer 126. For example, an indication that the transaction involving the first customer is invalid and an indication that the transaction involving the second customer is valid may be cached in read set validation result buffer 126. In various implementations, the results of the ledger reading set validation (i.e., the indication that the transaction involving the first customer is invalid and the indication that the transaction involving the second customer is valid) may be cached in read set validation result buffer 126 at least until they are compared to the results of the signature validation by crypto engine 122.

### Cryptographic Signature Validation

FIG. 3 illustrates a block diagram of an example of crypto engine 122 configured to perform one or more cryptographic operations required to verify the authenticity of transactions in a block, in accordance with one or more implementations of the invention. Crypto engine 122 may comprise an architecture configured to perform necessary cryptographic operations. In various implementations, one or more hardware components of crypto engine 122 may form a fixed pipeline hardware architecture configured to perform necessary cryptographic operations. In various implementations, the one or more hardware components of crypto engine 122 may include a data/CMD interface 302, a scheduler 304, a data buffer 306, one or more crypto execution units 308 (308a, 308b, . . . , 308n), a return data buffer 310, and/or one or more other components. In some implementations, crypto engine 122 may include multiple crypto execution units. For example, crypto engine 122 may include n-number of crypto execution units 308 wherein “n” is any number greater than 1. Crypto execution units 308 are also referred to herein as cryptographic execution units.

Cryptographic operations are implemented in system 100 via a highly-parallel architecture. In various implementations, crypto engine 122 may include multiple crypto execution units 308 configured to operate in parallel. In various implementations, crypto engine 122 may include multiple crypto execution units 308 configured to form a parallel cryptographic execution array. In various implementations, each individual crypto execution unit 308 is coupled to one or more other crypto execution units and is configured to share hardware resources with one or more other crypto execution units. For example, an individual crypto execution unit 308 may be configured to share a random number generator (e.g., shared random number generator 408) with one or more other crypto execution units. Other resources may be dedicated to individual crypto execution units. For example, one or more hardware resources (e.g., hashing and table lookup) may be dedicated to individual crypto execution units (e.g., crypto execution unit 308).

In various implementations, data required by one or more crypto execution units 308 may be obtained via data buffer 306. Data buffer 306 may be configured to cache data required to perform cryptographic operations related to authenticate cryptographic signatures for a block comprising a set of transactions. For example, data buffer 306 may be configured to cache algorithm parameters required to verify a cryptographic signature, hash values (e.g., hash public key and hash private key), and other data written to a block comprising a set of transactions crypto engine 122 is tasked to verify. In various implementations, data buffer 306 may be software-managed. In some implementations, data buffer 306 may be partitioned into different physical regions and each physical region may be associated with one or more different transactions. For example, each transaction may be assigned or be associated with a specific transaction ID. Each partitioned physical region of data buffer 306 may be associated with one or more specific transaction IDs. The partitioned nature of data buffer 306 enables information needed by the individual crypto execution units 308 to be easily accessed based on the transaction ID.

In various implementations, data buffer 306 may be configured to provide parameters to scheduler 304 to enable scheduler 304 to determine the type of algorithm required to authenticate a cryptographic signature but withhold hash values that are much larger in size and are not required by scheduler 304 to make the foregoing determination. For example, hash values may comprise 512 bits, public keys and/or private keys may comprise 256 bits, and cryptographic algorithm parameters may comprise 256 bits. Scheduler 304 may be configured to determine cryptographic operations required to authenticate a cryptographic signature using only the cryptographic algorithm parameters. Data buffer 306 may obtain data via data/CMD interface 302. Data/CMD interface 302 may comprise a high-speed and/or high-bandwidth interface. For example, data/CMD interface 302 may comprise a PCIe electrical interface or an Ethernet networking interface. In some implementations, data buffer 306 may be configured to prefetch transaction data, signatures, private keys, and/or other information associated with transactions to be verified. Once a cryptographic operation has been dispatched to a specific crypto execution unit 308, that crypto execution unit 308 may be configured to access the required information to perform the cryptographic operation from data buffer 306.

In various implementations, scheduler 304 may be configured to identify the cryptographic operations required to authenticate one or more cryptographic signatures and dispatch tasks related to the cryptographic signatures to at least one of the one or more crypto execution units 308. For example, scheduler 304 may be configured to identify the cryptographic operations required to authenticate one or more cryptographic signatures and coordinate tasks related to the cryptographic signatures to be performed by an array of crypto execution units as described in co-pending U.S. patent application Ser. No. 16/122,406, entitled “SYSTEMS AND METHODS FOR ACCELERATING TRANSACTION VERIFICATION BY PERFORMING CRYPTOGRAPHIC COMPUTING TASKS IN PARALLEL,” Attorney Docket No. 63PF-274817, the disclosure of which is hereby incorporated by reference in its entirety herein.

Each cryptographic operation may require a specific algorithm. For example, the cryptographic operation may require the elliptic curve digital signature algorithm (ECDSA), the ECDH algorithm, the RSA algorithm, the ASE algorithm, the zk-SNARKs algorithms, and/or one or more other specific algorithms. Each algorithm may have different priorities and/or parameters. In various implementations, scheduler 304 may be configured to identify the algorithmic parameters associated with one or more cryptographic signatures. In various implementations, scheduler 304 may be configured to determine the type of algorithm required to authenticate a cryptographic signature and the relevant parameters and dispatch the cryptographic signature to one of the one or more crypto execution units 308 based on the determination. In various implementations, scheduler 304 may be configured to determine the cryptographic operations required to authenticate one or more cryptographic signatures without accessing the hash values for the individual cryptographic signatures. In other words, scheduler 304 may be configured to determine the cryptographic operations required to authenticate one or more cryptographic signatures with only the algorithm and parameters associated with a given cryptographic signature to be verified.

In various implementations, scheduler 304 may be configured to cooperate with one or more software layers to support non-blocking transition cryptographic operations. For example, scheduler 304 may cooperate with one or more software layers to meet the demands of decentralized applications in which one or more transitions in a particular channel have a higher priority over other blocks. In some implementations, the one or more software layers may include a credit-control mechanism. The credit-control mechanism may comprise software configured to obtain an indication of the hardware limits and capabilities of system 100 and crypto execution units 308 in crypto engine 122 and verify that the number of transactions being processed does not exceed the hardware limits and capabilities of system 100 or crypto execution units 308. In some implementations, the credit-control mechanism may be configured to limit the number of transactions processed by system 100 at a given time to ensure the number of transactions being processed by system 100 does not exceed the hardware limits and capabilities of system 100. In some implementations, scheduler 304 may interface with the credit-control mechanism to limit the number of cryptographic operations being routed to individual crypto execution units 308 at a given time to ensure the number of cryptographic tasks being routed to individual crypto execution units 308 does not exceed the hardware limits and capabilities of system 100.

In some implementations, cryptographic operations may be dispatched by scheduler 304 to only a subset of the one or more crypto execution units 308. As such, one or more of a set of crypto execution units 308 may be idle at a given time while other crypto execution units 308 are performing cryptographic operations. In various implementations, crypto engine 122 may comprise a dispatcher configured to control the main dataflow for each crypto execution unit 308.

In various implementations, each of the one or more crypto execution units 308 may be associated with one or more cryptographic operations or one or more types of cryptographic operations. In other words, the one or more crypto execution units 308 may be configurable for different decentralized applications. For example, crypto execution unit 308a may be configured to perform a first cryptographic operation and crypto execution unit 308b may be configured to perform a second cryptographic operation. Accordingly, when operating in parallel, different cryptographic operations may performed simultaneously by different crypto execution units 308 configured to perform specific cryptographic operations.

In various implementations, each crypto execution unit 308 may be configured to support one or more of a set of macro operations required to authenticate one or more cryptographic signatures and verify a transaction in a decentralized application. For example, each crypto execution unit 308 may be configured to perform one or more of elliptic curve point multiplication; a SHA-1 hash function; modular addition, multiplication, and/or inversion; random number generation; and/or one or more other operations required to authenticate one or more cryptographic signatures and verify a transaction in a decentralized application.

Each crypto execution unit 308 may be configured to operate in parallel and perform one or more cryptographic operations required to verify the authenticity of transactions in a block. Because each of the crypto execution units may be associated with one or more cryptographic operations, the crypto execution units may be configurable for different decentralized applications. Accordingly, the implementation of each crypto execution unit 308 varies according to different elliptic curve parameters. Scheduler 304 is configured to issue specific cryptographic operations into the fitting crypto execution unit 308 based on the curve parameters associated with the required cryptographic operation, as described herein.

In some implementations, at least one crypto execution unit 308 may be configured to perform cryptographic operations related to the elliptic curve digital signature algorithm (ECDSA). For example, crypto engine 122 may be comprise at least one crypto execution unit 308 configured to perform cryptographic operations related to the elliptic curve digital signature algorithm (ECDSA) as described in co-pending U.S. patent application Ser. No. 16/122,406, entitled “SYSTEMS AND METHODS FOR ACCELERATING TRANSACTION VERIFICATION BY PERFORMING CRYPTOGRAPHIC COMPUTING TASKS IN PARALLEL,” Attorney Docket No. 63PF-274817, the disclosure of which is hereby incorporated by reference in its entirety herein.

Each crypto execution unit 308 of crypto engine 122 may be of the same type or a different type of one or more of the other crypto execution units 308 of crypto engine 122. For example, the types of crypto execution units 308 included within crypto engine 122 may include ECDSA SECP256K1 encrypt, ECDSA SECP256R1 encrypt, RSA encrypt, ASE encrypt, ECDH encrypt, Zk-SNARKs encrypt, ECDSA SECP256K1 decrypt, ECDSA SECP256R1 decrypt, RSA decrypt, ASE decrypt, ECDH decrypt, Zk-SNARKs decrypt, and/or one or more other types of crypto execution units.

In various implementations, each result of cryptographic operations performed by one of the one or more crypto execution units 308 may be temporarily stored in return data buffer 310. The time required to perform different cryptographic operations may vary. Accordingly, crypto execution units 308 may require different amounts of time to perform their assigned cryptographic operation. As such, in some implementations, the results from the cryptographic operations performed for a given block or set of transactions may be provided by crypto execution units 308 at different times. Accordingly, return data buffer 310 may be configured to temporarily store the results of cryptographic operations performed by crypto execution units 308 and reorder the results before the results are cached in signature validation result buffer 128.

In various implementations, return data buffer 310 may be software-managed. In some implementations, return data buffer 310 may be partitioned into different physical regions and each physical region may be associated with one or more different transactions. For example, each transaction may be assigned or be associated with a specific transaction ID. Each partitioned physical region of return data buffer 310 may be associated with one or more specific transaction IDs. Based on the transaction ID assigned to a given transaction, return data buffer 310 may be configured to push back the return value of the results of the signature validation by crypto engine 122 to data/CMD interface 302 in a software-defined order. In some implementations, data/CMD interface 302 may be configured to cause the results of the signature validation by crypto engine 122 that are pushed back to be cached in signature validation result buffer 128. The partitioned nature of return data buffer 310 enables the results of the individual cryptographic operations performed by the one or more crypto execution units 308 to be easily accessed and ordered based on the transaction ID to facilitate transaction verification for the transaction associated with the transaction ID by system 100.

### Pre-Execution Implementation

Validating the transactions in a block to be inserted into (or committed to) a blockchain is a critical and time-consuming aspect of blockchain maintenance and the management of decentralized applications. As described above, in order to validate a transaction in a block, two steps must be performed: (i) the endorsing signatures of each transaction must be validated; and (ii) the transaction must be verified by comparing the required pre-existing conditions for the transaction against a current state. When both the endorsing signatures have been validated and the transaction has been verified, the transaction is valid, and it may be recorded to the immutable ledger on the blockchain by updating a global state associated with the transaction. Otherwise, the transaction is invalid, in which case the transaction may still be written to the blockchain along with valid transactions, but the global state is not updated based on the transaction.

The life cycle of a transaction involves several critical stages: (i) transaction creation; (ii) endorsement; (iii) ordering; (iv) validation; and (v) commitment. At the outset, a transaction may be created in numerous circumstances. For instance, a transaction may be created when two parties reach an agreement to buy or sell something, to carry out an action, to provide a service, or to settle a dispute. In decentralized applications, when a transaction is created, at least one endorsement is required. Another user (such as a banker in the case of a bank transaction) may endorse a user's transaction. Once a contract is endorsed, a request may be sent to an ordering service responsible for generating a block. Each block may comprise multiple transactions, and the ordering service may order the multiple transactions within a given block. Once the block is generated, the block may be sent to a set of validation nodes to validate the multiple transactions within the block. Once the transactions are validated, the block comprising the transactions may be committed to a blockchain.

For example, and referring to FIG. 1 described herein, system 100 may be configured to process transaction verification operations in decentralized applications in order to validate the transactions within a block. In various implementations, system 100 may be configured to commit the block to a blockchain and update corresponding global states if both the endorsing signatures are validated and the transaction is verified. Accordingly, system 100 described herein may be configured to perform at least the (iv) validation and (v) commitment stages in the life cycle of a transaction described above.

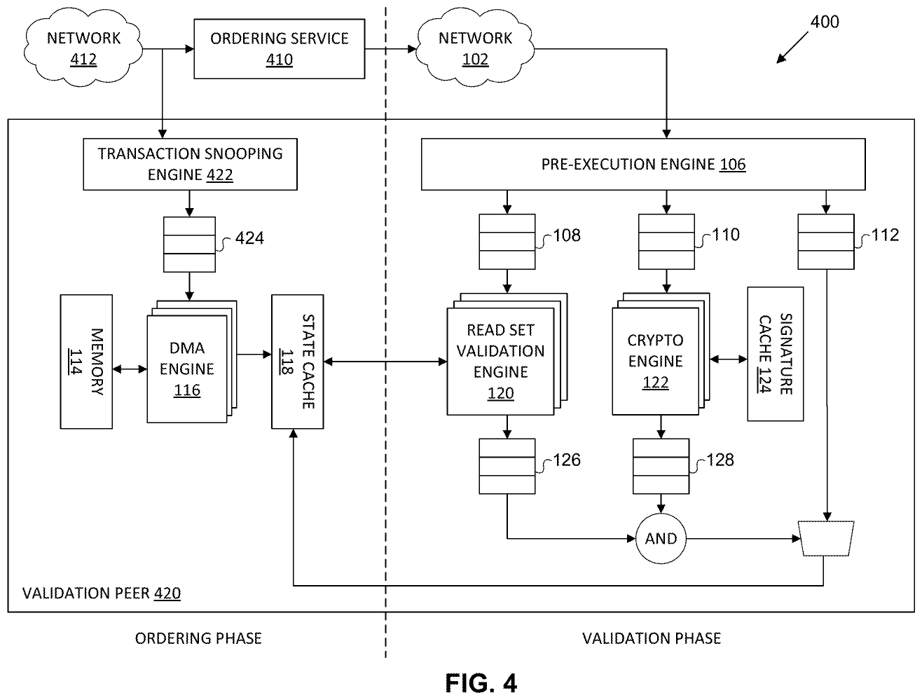

Typically, the ordering stage in the life cycle of a transaction is time-consuming, as the ordering service must determine the order of the transactions in a given block by reaching a consensus among nodes on a network. FIG. 4 illustrates a block diagram of a system 400 configured to pre-execute transactions for a decentralized application while a block comprising the transactions is being generated, in accordance with one or more implementations of the invention. In various implementations, system 400 may include an ordering service 410, a validation peer 420, and/or one or more other components.

In various implementations, ordering service 410 may be configured to sequence a series of transactions, generate a block comprising the transactions based on sequence, and transmit the block to nodes (or peers) on a peer-to-peer network for validation. Ordering service 420 may comprise a single orderer or a collection of orderers configured to sequence transactions, generate blocks, and transmit blocks to nodes (or peers) for validation. In various implementations, ordering service 420 may be configured to receive endorsed transactions via network 412. Once a block is generated, ordering service 420 may be configured to transmit the block to nodes (or peers) for validation via network 102. In some implementations, network 412 may comprise network 102, and/or a network the same as or similar to network 102. Once a block is generated and transmitted to nodes (or peers) for validation, the ordering stage for transactions in a given block has ended.

In various implementations, validation peer 420 may represent a single node in a peer-to-peer network that is configured to process transactions associated with a decentralized application. In various implementations, validation peer 420 may comprise a hardware component that includes all or a portion of system 100 described herein in connection with FIG. 1. For example, validation peer 420 may comprise an application specific integrated circuit (ASIC) or a field-programmable gate array (FPGA) configured to perform transaction verification operations associated with one or more decentralized applications. In some implementations, validation peer 420 may include pre-execution engine 106, read set holding buffer 108, signature validation buffer 110, write set holding buffer 112, local memory 114, DMA engine 116, state cache 118, read set validation engine 120, crypto engine 122, signature cache 124, read set validation result buffer 126, signature validation result buffer 128, and/or other components. In various implementations, validation peer 420 may further include a transaction snooping engine 422, a prefetching buffer 424, and/or one or more other components. In various implementations, transaction snooping engine 422, prefetching buffer 424, and/or one or more other hardware components of validation peer 420 may reside in a fixed pipeline hardware architecture described herein. Transaction snooping engine 422, prefetching buffer 424, and/or other components configured to perform one or more transaction verification operations during the ordering phase of a transaction life cycle may be referred to herein as “pre-execution hardware.”

In various implementations, the one or more hardware components of validation peer 420 may form a fixed pipeline hardware architecture configured to perform distributed ledger operations and accelerate the transaction verification process. For example, the one or more hardware components may configure validation peer 420 to verify the authenticity of transactions in a block, check the validity of the transactions, and/or commit (or write) the block and the validation results onto the blockchain. In various implementations, validation peer 420 may be configured to perform one or more transaction verification operations during the ordering phase of a transaction life cycle.

In various implementations, transaction snooping engine 422 may be configured to snoop network traffic for new transactions to be ordered during the ordering phase. For example, transaction snooping engine 422 may be configured to monitor network traffic for one or more transactions prior to the generation of a new block comprising the one or more transactions. In other words, transaction snooping engine 422 may be configured to snoop the network for new transactions to be ordered. In various implementations, transaction snooping engine 422 may be configured to snoop network 412 (or network 102) and/or traffic between network 412 (or network 102) and ordering service 410. For example, transaction snooping engine 422 may be configured to obtain an indication of all new transactions sent to ordering service 410.

In various implementations, transaction snooping engine 422 may be configured to obtain a read set and a write set for new transactions. A read set (also referred to herein as a “ledger reading set” or “read set data”) may contain a list of unique keys involved in a given transaction and the committed versions for those unique keys. A write set (also referred to herein as a “ledger writing set”) may contain a list of unique keys involved in a given transaction (which may overlap with the keys in the read set) and the new versions for those unique keys pending execution of the transaction. Read sets and write sets for a given transaction may be generated when a smart contract associated with a given transaction is executed. In various implementations, transaction snooping engine 422 may be configured to extract or prefetch the read set and write set for a new transaction prior to a new block comprising the new transaction being generated. In various implementations, transaction snooping engine 422 may be configured to insert read sets and/or write sets obtained for new transactions into prefetching buffer 424.

In various implementations, transaction snooping engine 422 may be configured to instruct DMA engine 116 to fetch data stored in electronic memory and required to verify whether a transaction and/or cryptographic signatures associated with the transaction are valid. For example, transaction snooping engine 422 may be configured to provide a read set and/or a write set for a new transaction cached in prefetching buffer 424 to DMA engine 116, prompting DMA engine 116 to fetch data stored in electronic memory and associated with the new transaction. In various implementations, DMA engine 116 may be configured to fetch existing blocks and signatures associated with a transaction. In various implementations, DMA engine 116 may be configured to access a ledger in memory required to validate data associated with a transaction. For example, DMA engine 116 may be configured to access local memory 114 to obtain a ledger required to validate data associated with a transaction. In various implementations, DMA engine 116 may be configured to fetch a local state related to a transaction that is required to verify the transaction. A local state related to a transaction may be based on a global state comprising one or more data points in a verified ledger written to the blockchain. In various implementations, DMA engine 116 may be configured to fetch the data for a given transaction based on the obtained read set and/or write set for that transaction.

In various implementations, DMA engine 116 may be configured to cache copies of the data fetched from electronic memory related to a new transaction prior to the generation of a block comprising the new transaction. For example, DMA engine 116 may be configured to cache copies of the data fetched from electronic memory in state cache 118.

Once a block comprising the new transaction is generated and provided to the nodes (or peers) for validation, validation peer 420 may be configured to validate the signature(s) associated with the transaction and verify the transaction by comparing the required pre-existing conditions for the transaction against a current (or local) state. For example, validation peer 420 may be configured to validate the signature(s) associated with the transaction as described herein with respect to crypto engine 122, FIG. 1, and FIG. 3, and verify the transaction by comparing the required pre-existing conditions for the transaction against a current (or local) state as described herein with respect to read set validation engine 120, FIG. 1, and FIG. 2.

In various implementations, validation peer 420 may be configured to receive a new block comprising a set of transactions via network 102. For example, validation peer 420 may be configured to receive a new block comprising one or more transactions. The new block may include at least cryptographic signatures to be authenticated that are associated with one or more of the transactions. Pre-execution engine 106 may be configured to insert portions of block received into one of a set of queues. A block comprising a set of transactions may include a read, cryptographic signatures to be authenticated, and a write set. In some implementations, the ledger reading set of an incoming block may be inserted into read set holding buffer 108, cryptographic signatures of an incoming block to be authenticated may be inserted into signature validation buffer 110, and the ledger writing set of an incoming block may be inserted into write set holding buffer 112.

In various implementations, read set validation engine 120 may be configured to fetch cached copies of the data fetched from electronic memory related to a new transaction in the block prior to the generation of the block. In various implementations, read set validation engine 120 may be configured to determine a transaction state for the new transaction based on the read set associated with the transaction. In various implementations, read set validation engine 120 may be configured to validate the read set against the global state based on the local state cached prior to the generation of the block. For example, read set validation engine 120 may be configured to validate the read set against the global state by comparing the determined transaction state to the local state cached prior to the generation of the block. In various implementations, the results of the read set validation by read set validation engine 120 may be cached in read set validation result buffer 126 at least until they are compared to results of the signature validation by crypto engine 122.

Crypto engine 122 may be configured to interface with signature cache 124 to obtain and cache data required to authenticate cryptographic signatures associated with a transaction. In various implementations, crypto engine 122 may be configured to verify whether the cryptographic signatures associated with the transaction are valid based on cryptographic operations performed on the cryptographic signatures by the one or more cryptographic execution units. In various implementations, the results of the signature validation by crypto engine 122 may be cached in signature validation result buffer 128 at least until they are compared to results of the read set validation by read set validation engine 120.

In various implementations, validation peer 420 may be configured to compare the results of the read set validation cached in read set validation result buffer 126 and the results of the signature validation cached in signature validation result buffer 128. Based on the comparison of the results of the read set validation and the results of the signature validation, validation peer 420 may be configured to write the transaction to the state cache and update the global state based on the transaction. If both the read set and the cryptographic signatures are valid, validation peer 420 may be configured to write the transaction to the state cache and update the global state based on the transaction. If either the read set or the cryptographic signatures are invalid, validation peer 420 is specifically configured to not update the global state based on the transaction.

Because the data for a new transaction is cached in a local buffer (e.g., in state cache 118) prior to the generation of a block comprising the new transaction (i.e., during the ordering phase), throughput transaction processing speed may be improved because read set validation engine 120 does not need to access local memory to obtain the data. Memory access requires hundreds of cycles, but accessing a local buffer only requires several cycles. As such, performance can be dramatically improved by fetching data associated with a new transaction while a block comprising the transaction is being generated (i.e., during the ordering phase) and caching that data for use when the block is generated and received by the validation peer (i.e., validation peer 420).

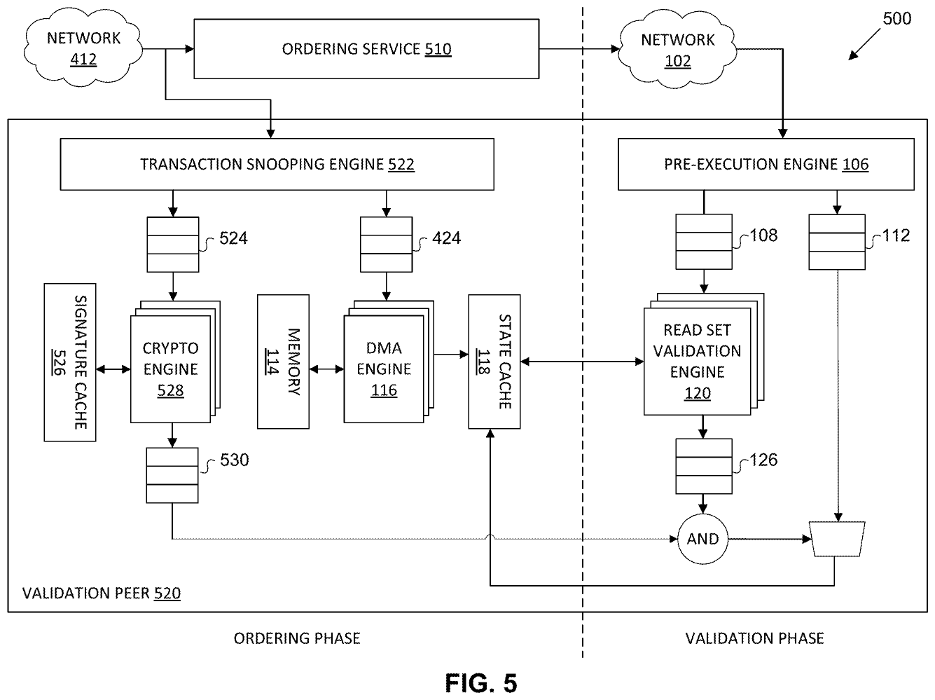

FIG. 5 illustrates a block diagram of a system 500 configured to pre-execute transactions for a decentralized application while a block comprising the transactions is being generated, in accordance with one or more implementations of the invention. In addition to snooping for new transactions and caching data necessary to verify new transactions and/or validate signatures associated with new transactions (as described herein with respect to system 400 depicted in FIG. 4), system 500 may be configured to execute signature validations during the ordering phase of a transaction life cycle. In various implementations, system 500 may include an ordering service 510, a validation peer 520, and/or one or more other components. In various implementations, ordering service 510 may comprise an ordering service the same as or similar to ordering service 410 described herein with respect to FIG. 4.

In various implementations, validation peer 510 may represent a single node in a peer-to-peer network that is configured to process transactions associated with a decentralized application. In various implementations, validation peer 520 may comprise a hardware component that includes all or a portion of system 100 described herein in connection with FIG. 1. For example, validation peer 520 may comprise an application specific integrated circuit (ASIC) or a field-programmable gate array (FPGA) configured to perform transaction verification operations associated with one or more decentralized applications. In some implementations, validation peer 520 may include pre-execution engine 106, read set holding buffer 108, write set holding buffer 112, local memory 114, DMA engine 116, state cache 118, read set validation engine 120, read set validation result buffer 126, and/or other components. In various implementations, validation peer 520 may further include a prefetching buffer 424, a transaction snooping engine 522, a signature validation buffer 524, a signature cache 526, a crypto engine 528, a signature validation result buffer 530, and/or other components. In various implementations, prefetching buffer 424, transaction snooping engine 522, signature validation buffer 524, signature cache 526, crypto engine 528, signature validation result buffer 530, and/or one or more other hardware components of validation peer 520 may reside in a fixed pipeline hardware architecture described herein. Prefetching buffer 424, transaction snooping engine 522, signature validation buffer 524, signature cache 526, crypto engine 528, signature validation result buffer 530, and/or other components configured to perform one or more transaction verification operations during the ordering phase of a transaction life cycle may be referred to herein as “pre-execution hardware.”

In various implementations, the one or more hardware components of validation peer 520 may form a fixed pipeline hardware architecture configured to perform distributed ledger operations and accelerate the transaction verification process. For example, the one or more hardware components may configure validation peer 520 to verify the authenticity of transactions in a block, check the validity of the transactions, and/or commit (or write) the block and the validation results onto the blockchain. In various implementations, validation peer 520 may be configured to perform one or more transaction verification operations during the ordering phase of a transaction life cycle.

In various implementations, transaction snooping engine 522 may be configured to snoop network traffic for new transactions to be ordered during the ordering phase. In various implementations, transaction snooping engine 522 may be configured to obtain a read set and a write set for new transactions. In various implementations, transaction snooping engine 522 may be configured to insert read sets and/or write sets obtained for new transactions into prefetching buffer 424. In various implementations, transaction snooping engine 522 may be configured to instruct DMA engine 116 to fetch data stored in electronic memory and required to verify whether a transaction and/or cryptographic signatures associated with the transaction are valid. Transaction snooping engine 522 may comprise a hardware component the same as or similar to transaction snooping engine 422. In other words, transaction snooping engine 522 may be configured to perform each of the operations described herein with respect to transaction snooping engine 422.

In some implementations, transaction snooping engine 522 may be configured to obtain cryptographic signatures associated with new transactions to be ordered. For example, transaction snooping engine 522 may be configured to extract or fetch cryptographic signatures required to be validated for each new transaction identified from network traffic (e.g., network traffic to ordering service 510). Accordingly, the information needed to perform signature validation for a transaction may be obtained during the ordering phase prior to a block comprising the transaction being generated. In some implementations, transaction snooping engine 522 may be configured to insert cryptographic signatures obtained for new transactions into signature validation buffer 524 prior to generation of a new block comprising the new transaction.

In various implementations, DMA engine 116 may be configured to fetch existing blocks and signatures associated with a transaction. For example, as described herein with respect to FIG. 4, DMA engine 116 may be configured to fetch a local state related to a transaction that is required to verify the transaction. In various implementations, DMA engine 116 may be configured to fetch the data for a given transaction based on the obtained read set and/or write set for that transaction. In various implementations, DMA engine 116 may be configured to cache copies of the data fetched from electronic memory related to a new transaction prior to the generation of a block comprising the new transaction.

In some implementations, crypto engine 528 may be configured to perform signature validation for a transaction by authenticating cryptographic signatures associated with a new transaction prior to the generation of a block comprising the new transaction. Crypto engine 528 may comprise a hardware component the same as or similar to crypto engine 122. In various implementations, crypto engine 528 may be configured to receive cryptographic signatures to be authenticated associated with a transaction from signature validation buffer 524. In various implementations, crypto engine 528 may be configured to verify whether the cryptographic signatures associated with the transaction are valid based on cryptographic operations performed on the cryptographic signatures by the one or more cryptographic execution units. Crypto engine 528 may be configured to interface with signature cache 526 to obtain and cache data required to authenticate cryptographic signatures associated with the transaction. In various implementations, the results of the signature validation by crypto engine 526 may be cached in signature validation result buffer 530 at least until they are compared to results of the read set validation by read set validation engine 120.

By prefetching data needed to process a transaction and performing cryptographic signature validation for the transaction prior to a block being generated comprising the transaction (i.e., during the ordering phase), throughput transaction processing speed may be improved even further. Cryptographic signature validation may be performed during the ordering phase as the results of cryptographic signature validation does not depend on the order of the transactions in a block. During the validation phase (i.e., after the block is generated and validation peer 520 receives the block), validation peer 520 need only conduct pre-existing state checks (i.e., verifying the transaction by comparing the required pre-existing conditions for the transaction against a current state) to validate the new transaction. For example, once a block comprising the new transaction is generated and provided to the nodes (or peers) for validation, validation peer 520 may be configured to verify the transaction by comparing the required pre-existing conditions for the transaction against a current (or local) state. For example, validation peer 520 may be configured to verify the transaction by comparing the required pre-existing conditions for the transaction against a current (or local) state as described herein with respect to read set validation engine 120, FIG. 1, and FIG. 2.

In various implementations, validation peer 520 may be configured to receive a new block comprising a set of transactions via network 102. For example, validation peer 520 may be configured to receive a new block comprising one or more transactions. The new block may include at least cryptographic signatures to be authenticated that are associated with one or more of the transactions. Pre-execution engine 106 may be configured to insert portions of block received into one of a set of queues (e.g., read set holding buffer 108 and write set holding buffer 112). In various implementations, read set validation engine 120 may be configured to fetch cached copies of the data fetched from electronic memory related to a new transaction in the block prior to the generation of the block. In various implementations, read set validation engine 120 may be configured to determine a transaction state for the new transaction based on the read set associated with the transaction. In various implementations, read set validation engine 120 may be configured to validate the read set against the global state based on the local state cached prior to the generation of the block. For example, read set validation engine 120 may be configured to validate the read set against the global state by comparing the determined transaction state to the local state cached prior to the generation of the block. In various implementations, the results of the read set validation by read set validation engine 120 may be cached in read set validation result buffer 126 at least until they are compared to results of the signature validation by crypto engine 122.

Validation peer 520 may be configured to compare the results of the read set validation cached in read set validation result buffer 126 and the results of the signature validation cached in signature validation result buffer 128 prior to the generation of the block comprising the transaction. Based on the comparison of the results of the read set validation and the results of the signature validation, validation peer 520 may be configured to write the transaction to the state cache and update the global state based on the transaction. If both the read set and the cryptographic signatures are valid, validation peer 520 may be configured to write the transaction to the state cache and update the global state based on the transaction. If either the read set or the cryptographic signatures are invalid, validation peer 520 is specifically configured to not update the global state based on the transaction.

In various implementations, validation peer 520 may be configured to conduct pre-existing state checks during the ordering phase. For example, validation peer 520 may be configured to verify the transaction by comparing the required pre-existing conditions for the transaction against a current state prior to the generation of the new block comprising the transaction being verified. In other words, in some implementations, read set validation engine 120 may be configured to verify whether a transaction is valid prior to the generation of a new block comprising that transaction. Conducting the pre-existing state checks during the ordering phases further reduces the processing required during the validation phase (i.e., after the block is generated).

In some implementations, a single block may contain multiple transactions involving the same user and/or the same cryptographic signature. Accordingly, verifying whether a transaction is valid may depend on the order of transactions in a given block. In an exemplary implementation, a single customer may submit two separate stock orders (i.e., a first transaction and a second transaction). Both the first transaction and the second transaction may be associated with the same cryptographic signature. Depending on the time between the first transaction and the second transaction, the transactions may appear in the same block. In the event the user's broker account only has enough money for one of the two transactions, the order of the transactions in the block may affect the verification of the transaction. In some implementations in which validation peer 520 conducts pre-existing state checks during the ordering phase, validation peer 520 may be configured to detect an order of transactions associated with the same cryptographic signature in a received new block. Based on the detected order of the transactions associated with the same cryptographic signature, validation peer 520 may be configured to reverify whether each of the transactions associated with the same cryptographic signature in a new block are valid.

### Exemplary Flowcharts of Processes

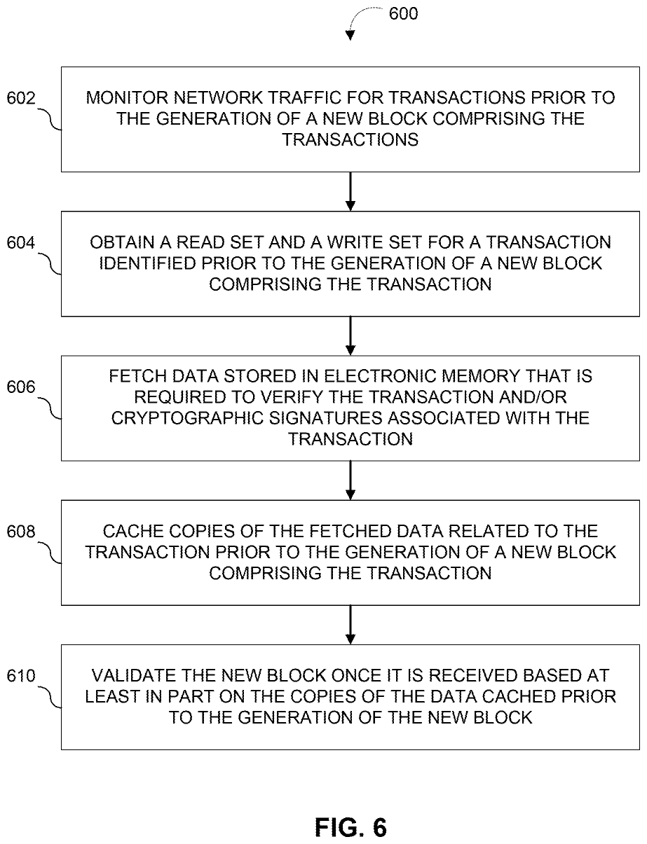

FIG. 6 illustrates a method 600 for pre-executing transactions for a decentralized application while a block comprising the transactions is being generated, in accordance with one or more implementations of the invention. The operations of method 600 presented below are intended to be illustrative and, as such, should not be viewed as limiting. In some implementations, method 600 may be accomplished with one or more additional operations not described, and/or without one or more of the operations discussed. In some implementations, two or more of the operations may occur substantially simultaneously. The described operations may be accomplished using some or all of the system components described in detail above.

In some implementations, method 600 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 600 in response to instructions stored electronically on one or more electronic storage mediums. The one or more processing devices may include one or more devices configured through hardware, firmware, and/or software to be specifically designed for execution of one or more of the operations of method 600.

In some implementations, one or more operations of method 600 may be implemented via a hardware device configured to be communicatively coupled or physically attached to a component of a computer system. For example, one or more operations of method 600 may be implemented via the hardware device described above with respect to system 100, system 400, and/or system 500. The aforementioned hardware devices may include one or more hardware components configured through firmware and/or software to be specifically designed for execution of one or more operations of method 600. In some implementations, one or more operations of method 600 may be implemented on an application specific integrated circuit (ASIC) or a field-programmable gate array (FPGA) specifically designed for execution of one or more operations of method 600.

In an operation 602, method 600 may include monitoring network traffic for transactions prior to the generation of a new block comprising the transactions. For example, network traffic may be snooped for new transactions to be ordered during the ordering phase. In some implementations, network traffic may be monitored to snoop, identify, and/or obtain all new transactions before they are sent to an ordering service for ordering. In various implementations, operation 602 may be performed by a computer processing unit the same as or similar to transaction snooping engine 422 and/or transaction snooping engine 522 (shown in FIG. 4 and FIG. 5 and described herein).

In an operation 604, method 600 may include obtaining a read set and/or a write set for a new transaction identified prior to the generation of a new block comprising the transaction. Read sets and write sets for a given transaction may be generated when a smart contract associated with a given transaction is executed. Read sets and/or write sets for a new transaction may be extracted or prefetched prior to a new block comprising the new transaction being generated. In various implementations, prefetched read sets and/or write sets for new transactions may be inserted into a prefetching buffer. In various implementations, operation 604 may be performed by a computer processing unit the same as or similar to transaction snooping engine 422 and/or transaction snooping engine 522 (shown in FIG. 4 and FIG. 5 and described herein).

In an operation 606, method 600 may include fetching data stored in electronic memory that is required to verify the transaction and/or cryptographic signatures associated with the transaction. In various implementations, the data fetched may be based on a read set and/or a write set associated with at least one transaction to be ordered. In some implementations, data fetched may include cryptographic signatures to be authenticated associated with a transaction. In various implementations, operation 606 may be performed by a computer processing unit the same as or similar to DMA engine 116 (shown in FIG. 1, FIG. 4, and FIG. 5 and described herein).

In an operation 608, method 600 may include caching copies of the fetched data related to the transaction prior to the generation of a new block comprising the transaction. In various implementations, copies of the data fetched from electronic memory related to a new transaction may be cached prior to the generation of a block comprising the new transaction in local memory. In various implementations, operation 608 may be performed by a computer processing unit the same as or similar to DMA engine 116 (shown in FIG. 1, FIG. 4, and FIG. 5 and described herein).

In an operation 610, method 600 may include committing the validated transaction to a blockchain. In various implementations, new blocks may be received related to one or more transactions. Each new block may include at least cryptographic signatures associated with the one or more transactions. In various implementations, the copies of the data cached prior to the generation of the new block may be fetched. The copies of the data cached prior to the generation of the new block may include at least a local state related to one or more transactions. To validate a transaction, (i) the transaction may be verified by comparing a local state associated with the transaction and a transaction state for the transaction determined based on a read set for the transaction, and (ii) cryptographic signatures associated with the transaction may be verified based on cryptographic operations performed on the cryptographic signatures by one or more cryptographic execution units. In various implementations, the one or more cryptographic execution units may comprise a set of cryptographic execution units operating in parallel. In some implementations, each of the set of cryptographic execution units may be configured to perform one or more types of cryptographic operations. In some implementations, the cryptographic signatures associated with a transaction may be verified prior to the generation of a new block comprising the transaction and/or an indication of whether the cryptographic signatures associated with the transaction are valid may be cached in a buffer until a new block comprising the transaction is generated. In some implementations, a transaction may be verified by comparing the local state and the transaction state for the transaction prior to the generation of new block comprising that transaction. In the event a transaction is verified prior to the generation of a new block comprising that transaction, the transaction may be reverified after the block is generated. For example, a single block may comprise multiple transactions associated with a single user (or cryptographic signature). In some implementations, an order of multiple transactions associated with a single user (or cryptographic signature) may be detected and the multiple transactions associated with the single user (or cryptographic signature) may be reverified based on the detected order of the multiple transactions. In some implementations, an indication of whether a transaction is valid (i.e., based on a comparison of the local state and the transaction state for the transaction) may be cached in a buffer until the indication may be compared to an indication of whether cryptographic signatures associated with that transaction are valid. For example, an indication of whether cryptographic signatures associated with a transaction are valid or invalid cached in one buffer may be compared to an indication of whether that transaction is valid or invalid cached in a second buffer. Responsive to the verification of both (i) the transaction and (ii) the cryptographic signatures associated with the transaction, the transaction may be committed to a blockchain and a local state related to the transaction may be updated in electronic memory.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although illustrated in FIG. 1 as a single component, system 100 may include a plurality of individual components (e.g., computer devices) each programmed with at least some of the functions described herein. In this manner, some components of system 100 may perform some functions while other components may perform other functions, as would be appreciated.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein. For example, the use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

The language used herein has been principally selected for readability and instructional purposes, and it may not have been selected to delineate or circumscribe the inventive subject matter. Other implementations, uses, and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system configured to pre-execute transactions for a decentralized application while a block comprising the transactions is being generated, the system comprising:
pre-execution hardware residing in a fixed pipeline hardware architecture, wherein the pre-execution hardware is configured to:
monitor network traffic for one or more transactions prior to generation of a new block comprising the one or more transactions, wherein the one or more transactions include at least a first transaction;
obtain a read set and a write set associated with the first transaction;
fetch data stored in electronic memory and required to verify whether the first transaction and cryptographic signatures associated with the first transaction are valid, wherein the data fetched is based on the read set and the write set associated with the first transaction; and
cache copies of the data prior to the generation of the new block comprising the one or more transactions.

2. The system of claim 1, wherein the system is configured to receive the new block related to the one or more transactions, the new block including at least cryptographic signatures to be authenticated associated with the first transaction, wherein the system further comprises:
a read set validation engine configured to:
fetch the copies of the data cached prior to the generation of the new block, wherein the copies of the data cached prior to the generation of the new block includes a local state related to the first transaction,
determine a transaction state for the first transaction based on the read set associated with the first transaction; and
verify whether the first transaction is valid based on a comparison of the local state and a transaction state for the first transaction determined based on the read set; and
a crypto engine comprising one or more cryptographic execution units, wherein the crypto engine is configured to:
verify whether the cryptographic signatures associated with the first transaction are valid based on cryptographic operations performed on the cryptographic signatures by the one or more cryptographic execution units.

3. The system of claim 2, wherein the one or more cryptographic execution units comprise a set of cryptographic execution units operating in parallel, wherein each of the set of cryptographic execution units is configured to perform one or more types of cryptographic operations.

4. The system of claim 2, responsive to a determination that both the first transaction and cryptographic signatures associated with the first transaction are valid, the system is configured to:
commit at least the first transaction to a blockchain; and
update the local state related to the first transaction in electronic memory.

5. The system of claim 2, wherein the pre-execution hardware is further configured to:
fetch the cryptographic signatures to be authenticated associated with the first transaction prior to the generation of the new block,
wherein the cryptographic signatures associated with the first transaction are verified prior to the generation of the new block.

6. The system of claim 5, wherein the crypto engine is further configured to:
cause an indication of whether the cryptographic signatures are valid or invalid to be cached in a first buffer until the new block has been generated.

7. The system of claim 6, wherein the system is further configured to:
cause an indication of whether the transaction is valid or invalid based on the comparison to be cached in a second buffer;
compare the indication of whether the cryptographic signatures are valid or invalid cached in the first buffer prior to generation of the new block and the indication of whether the transaction is valid or invalid cached in the second buffer; and
responsive to a determination that both the cryptographic signatures and the transaction are valid based on the comparison, commit the transaction to the blockchain and updating the local state based on the transaction.

8. The system of claim 5, wherein the read set validation engine configured to:
verify whether the first transaction is valid prior to the generation of the new block comprising the one or more transactions.

9. The system of claim 8, wherein the one or more transactions in the new block include at least two transactions related to a first cryptographic signature, wherein the at least two transactions include the first transaction, wherein the system is further caused to:
detect an order of the at least two transactions in the new block related to the first cryptographic signature; and
reverify whether the first transaction is valid based on the order of the at least two transactions in the new block.

10. The system of claim 1, wherein the system comprises an application specific integrated circuit (ASIC) or a field-programmable gate array (FPGA).

11. A method of pre-executing transactions for a decentralized application while a block comprising the transactions is being generated, the method being implemented on a computing device comprising a fixed pipeline hardware architecture, the method comprising:
monitoring network traffic for one or more transactions prior to generation of a new block comprising the one or more transactions, wherein the one or more transactions include at least a first transaction;
obtaining a read set and a write set associated with the first transaction;
fetching data stored in electronic memory and required to verify whether the first transaction and cryptographic signatures associated with the first transaction are valid, wherein the data fetched is based on the read set and the write set associated with the first transaction; and
caching copies of the data prior to the generation of the new block comprising the one or more transactions.

12. The method of claim 11, the method further comprising:
receiving the new block related to the one or more transactions, wherein the new block includes at least cryptographic signatures to be authenticated associated with the first transaction;
fetching the copies of the data cached prior to the generation of the new block, wherein the copies of the data cached prior to the generation of the new block includes a local state related to the first transaction;
verifying whether the first transaction is valid based on a comparison of the local state and a transaction state for the first transaction determined based on the read set associated with the first transaction; and
verifying whether the cryptographic signatures associated with the first transaction are valid based on cryptographic operations performed on the cryptographic signatures by one or more cryptographic execution units.

13. The method of claim 12, wherein the one or more cryptographic execution units comprise a set of cryptographic execution units operating in parallel, wherein each of the set of cryptographic execution units is configured to perform one or more types of cryptographic operations.

14. The method of claim 12, responsive to a determination that both the first transaction and cryptographic signatures associated with the first transaction are valid, the method further comprising:
committing at least the first transaction to a blockchain; and
updating the local state related to the first transaction in electronic memory.

15. The method of claim 12, the method further comprising:
fetching the cryptographic signatures to be authenticated associated with the first transaction prior to the generation of the new block,
wherein the cryptographic signatures associated with the first transaction are verified prior to the generation of the new block.

16. The method of claim 15, the method further comprising:
causing an indication of whether the cryptographic signatures are valid or invalid to be cached in a buffer until the new block has been generated.

17. The method of claim 16, the method further comprising:
causing an indication of whether the transaction is valid or invalid based on the comparison to be cached in a second buffer;
comparing the indication of whether the cryptographic signatures are valid or invalid cached in the first buffer prior to generation of the new block and the indication of whether the transaction is valid or invalid cached in the second buffer; and
responsive to a determination that both the cryptographic signatures and the transaction are valid based on the comparison, committing the transaction to the blockchain and updating the local state based on the transaction.

18. The method of claim 15, the method further comprising:
verifying whether the first transaction is valid prior to the generation of the new block comprising the one or more transactions.

19. The method of claim 18, wherein the one or more transactions in the new block include at least two transactions related to a first cryptographic signature, wherein the at least two transactions include the first transaction, the method further comprising:
detecting an order of the at least two transactions in the new block related to the first cryptographic signature; and
reverifying whether the first transaction is valid based on the order of the at least two transactions in the new block.

20. The method of claim 11, wherein the method is implemented on an application specific integrated circuit (ASIC) or a field-programmable gate array (FPGA).
